(19) United States
(12) Patent Application Publication
(10) Pub. No.: US 2016/0031369 A1
(43) Pub. Date: Feb. 4, 2016

(54) COLOR ON DEMAND SYSTEM WITH COLOR GRADIENT

(71) Applicant: Continental Automotive Systems, Inc., Auburn Hills, MI (US)

(72) Inventor: Heath D. Zietz, Ortonville, MI (US)

(21) Appl. No.: 14/448,743

(22) Filed: Jul. 31, 2014

(51) Int. Cl. B60Q 3/04; F21K 99/00

(52) U.S. Cl. CPC B60Q 3/044; F21K 9/52; B60Q 3/048; F21Y 2101/02

(57) ABSTRACT

An instrument cluster assembly includes at least a first and a second light-emitting diode package, each having at least a first-colored light and a second-colored light. The light-emitting diode packages are reconfigurable to display a first color and a second color. The first light-emitting diode package is configured to display a first intensity of the first color. The second light-emitting diode package is configured to display a second intensity of the first color simultaneously with the display of the first intensity of the first color by the first light-emitting diode package. The second intensity of the first color is less than the first intensity of the first color to provide an appearance of a gradient between the first and second light-emitting diode packages. A system for illuminating an instrument cluster assembly and a non-transitory machine-readable medium are also disclosed.

### TECHNICAL FIELD

The present disclosure relates to automotive interiors, and more particularly, to instrument cluster assemblies that are lit by one or more light-emitting diode packages.

### BACKGROUND

Vehicles include instrument clusters and gauges for communicating desired operating parameters such as vehicle speed, engine service needs, vehicle temperature, fuel level, among other operating parameters. Different methods and devices are known for communicating this information. Each method and device provides not only the function of communicating operating information to a driver, but also form and contribute to the style and aesthetic appearance of a vehicle interior. Accordingly, it is desirable to develop new and unique devices and methods for communicating and representing vehicle operating information to contribute to a desired appearance.

### SUMMARY

Disclosed is a device and system that lights up primary colors and blended colors that are a percentage of the primary colors, based on adjacent locations of the lights, to produce a gradient color pattern. The lights may be reconfigurable to provide different colors having different gradient color patterns.

In one form, which may be combined with or separate from the other forms described herein, an instrument cluster assembly includes a first light-emitting diode package having a first-colored light and a second-colored light. The first light-emitting diode package is reconfigurable to display a first color and a second color. The first light-emitting diode package is configured to display a first intensity of the first color. A second light-emitting diode package has a first-colored light and a second-colored light. The second light-emitting diode package is disposed adjacent to the first light-emitting diode package and spaced apart from the first light-emitting diode package. The second light-emitting diode package is reconfigurable to display the first color and the second color. The second light-emitting diode package is configured to display a second intensity of the first color simultaneously with the display of the first intensity of the first color by the first light-emitting diode package. The second intensity of the first color is less than the first intensity of the first color to provide an appearance of a gradient between the first and second light-emitting diode packages.

In another form, which may be combined with or separate from the other forms described herein, a system for illuminating an instrument cluster assembly includes first and second light-emitting diode packages and a processor. The first light-emitting diode package has a first-colored light and a second-colored light. The first light-emitting diode package is reconfigurable to display a first displayed color and a second displayed color. The second light-emitting diode package also has a first-colored light and a second-colored light. The second light-emitting diode package is disposed adjacent to the first light-emitting diode package and spaced apart from the first light-emitting diode package. The second light-emitting diode package is reconfigurable to display the first displayed color and the second displayed color. The processor is controllably connected to the first light-emitting diode package and the second light-emitting diode package. The processor is configured to cause the first light-emitting diode package to display a first intensity of the first displayed color at a first time and to cause the second light-emitting diode package to display a second intensity of the first displayed color at the first time. The second intensity of the first displayed color is less than the first intensity of the first displayed color to provide an appearance of a gradient between the first and second light-emitting diode packages.

In yet another form, which may be combined with or separate from the other forms described herein, disclosed is a non-transitory machine-readable medium that provides instructions, which when executed by a machine, cause the machine to perform certain operations. The operations include displaying a first intensity of a first displayed color via a first light-emitting diode package at a first time; displaying a second intensity of the first displayed color via a second light-emitting diode package at the first time, the second intensity being less than the first intensity to provide an appearance of a gradient between the first and second light-emitting diode packages at the first time; and displaying a first intensity of a second displayed color via the first light-emitting diode package at a second time.

Further features and advantages of the present disclosure will become apparent from consideration of the following description and the appended claims, when taken in connection with the accompanying drawings. It should be understood that the description and specific examples are intended for purposes of illustration only and are not intended to limit the scope of the present disclosure.

### BRIEF DESCRIPTION OF THE DRAWINGS

Examples are reflected in the drawings, which will be described below. The drawings described herein are for illustration purposes only and are not intended to limit the scope of the present disclosure in any way.

The patent or application file contains at least one drawing executed in color. Copies of this patent or patent application publication with color drawing(s) will be provided by the Office upon request and payment of the necessary fee.

The drawings show:

FIG. 1 is a front view of an instrument cluster assembly, according to the principles of the present disclosure;

FIG. 2A is a black-and-white line drawing front view of a frame portion of the instrument cluster assembly of FIG. 1 at a first time, in accordance with the principles of the present disclosure;

FIG. 2B is a grayscale drawing version of the frame portion of the instrument cluster assembly of FIG. 2A at a first time, according to the principles of the present disclosure;

FIG. 2C is a color drawing version of the frame portion of the instrument cluster assembly of FIGS. 2A-2B at a first time, in accordance with the principles of the present disclosure;

FIG. 3 is a cross-sectional view of the instrument cluster assembly of FIGS. 1-2C, taken along the lines 3-3 of FIG. 2A, according to the principles of the present disclosure;

FIG. 4A is a black-and-white line drawing front view of a strip indicator of the instrument cluster assembly of FIG. 1 at a first time, in accordance with the principles of the present disclosure;

FIG. 4B is a grayscale drawing version of the strip indicator of the instrument cluster assembly of FIG. 4A at a first time, according to the principles of the present disclosure;

FIG. 4C is a color drawing version of the strip indicator of the instrument cluster assembly of FIGS. 4A-4B at a first time, in accordance with the principles of the present disclosure;

FIG. 5 is a block diagram illustrating a system for illuminating an instrument cluster assembly, according to the principles of the present disclosure; and

FIG. 6 is a block diagram of a method for illuminating an instrument cluster assembly, which may be embodied in a non-transitory machine-readable medium, in accordance with the principles of the present disclosure.

### DETAILED DESCRIPTION

The following description is merely exemplary in nature and is not intended to limit the present disclosure, application, or uses.

Certain terms are used throughout the following description and claims to refer to particular system components and configurations. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”.

Examples of the invention are described below. It should be noted that these and other examples or embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art. Other embodiments may be utilized, and other changes may be made, without departing from the spirit or scope of the subject matter presented here.

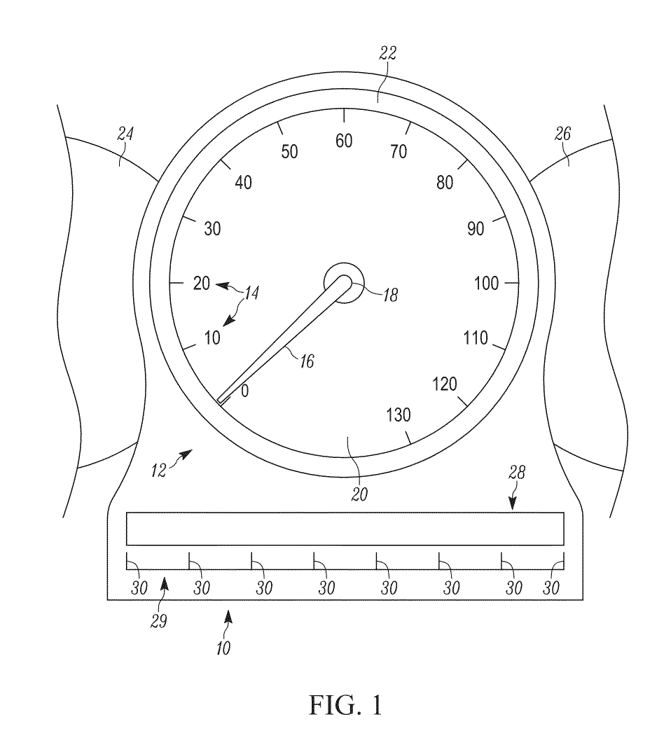

With reference to FIG. 1, an instrument cluster assembly in accordance with the present disclosure is illustrated and generally designated at 10. The instrument cluster assembly 10 may be used in a motor vehicle, for example, to display certain operating parameters to a driver. Information given by the instrument cluster assembly 10 may include, by way of example, tachometer information, vehicle speed information, fuel level information, engine temperature, or any other information that is desired to communicate to the driver of the vehicle.

The instrument cluster assembly 10, in this example, includes an indicator dial 12, which may be used to indicate speed, by way of example. As such, the indicator dial 12 includes a plurality of tick marks or parameters 14 distributed in a circular pattern around a face 20 of the indicator dial 12 and a pointer 16 that may be rotated by a shaft 18 to move the pointer 16 along the face 20 of the indicator dial 12. The parameters 14 or other indicators may be printed, engraved, or otherwise disposed around the circumference of the face 20 of the indicator dial 12. For example, the parameters 14 may include numerical values corresponding to speed (in this example), or RPM, temperature, fuel level, or other operating parameters of the vehicle. The face 20 of the indicator dial 12 may consist mostly of opaque material, in order to hide components that are disposed adjacent to a back side of the indicator dial 12, such as circuitry and lighting assemblies. A frame 22 is disposed over the face 20 of the indicator dial 12, which will be described in more detail below.

Peripheral indicator dials 24, 26 may be disposed adjacent to the indicator dial 12, to indicate other operating parameters of the vehicle. For example, the indicator dials 24, 26 could be used to indicate tachometer information, fuel level information, engine temperature, or any other information that is desired to communicate to the driver of the vehicle. The indicator dials 24, 26 could be reconfigurable to show various sets of vehicle parameters, by way of example.

A strip indicator 28 may be disposed adjacent to the indicator dial 12, for illustrating still another operating parameter. For example, the strip indicator 28 is operable to illustrate engine temperature in this configuration. As such, the strip indicator 28 may have a parameter strip 29 with a plurality of tick marks 30 disposed adjacent to the strip indicator 28 to provide a visual indication of the engine temperature. It should be understood that the indicator dial 12 and the strip indicator 28 could be employed separately of each other, and need not be used together in the same instrument cluster or vehicle, without falling beyond the spirit and scope of the present disclosure.

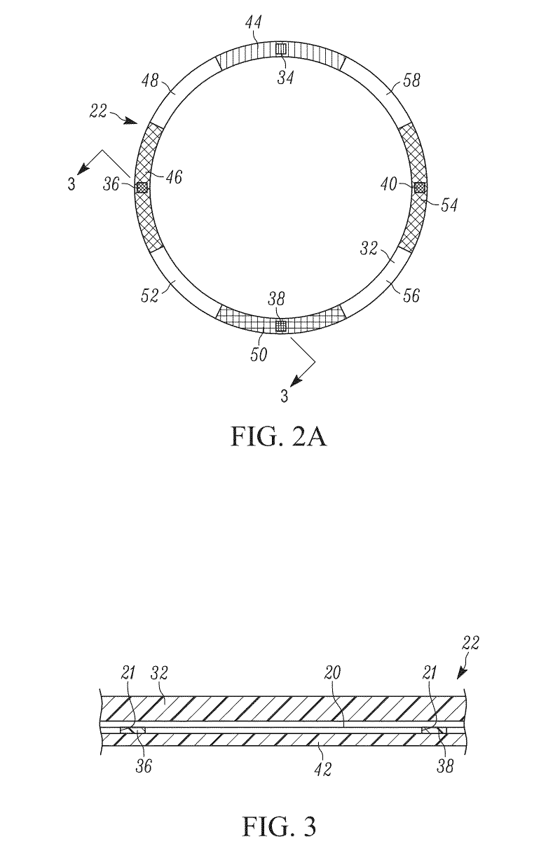

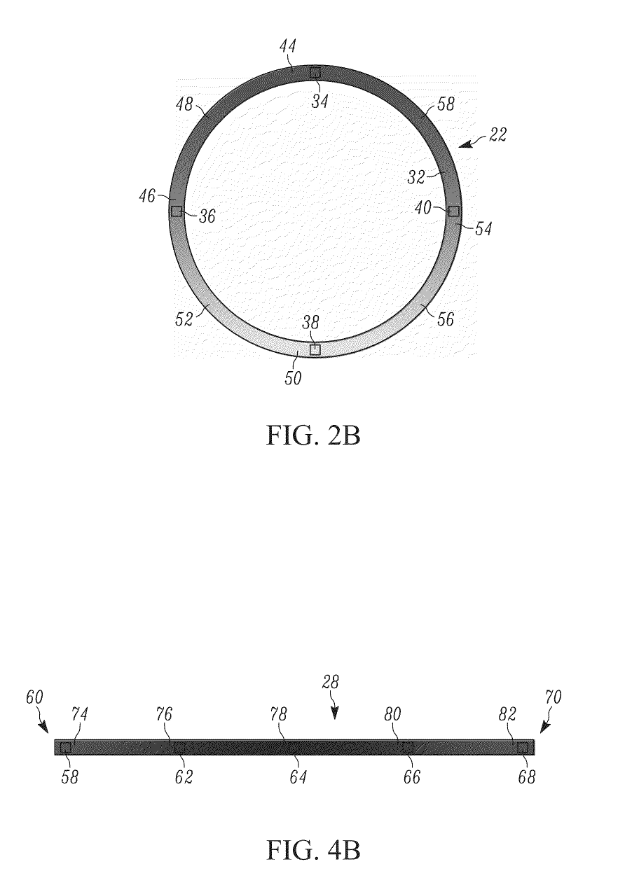

Referring now to FIGS. 2A-2C, additional details of the frame 22 are shown and described. FIG. 2A is a black-and-white line drawing of the frame 22, while FIG. 2B is a grayscale view of the frame 22, and FIG. 2C illustrates the frame 22 in color. FIG. 3 shows a side view of a portion of the frame 22, taken along the line 3-3 of FIG. 2A. The frame 22 includes at least one light guide 32, which may be a plastic lens, acrylic, or light housing, by way of example. The light guide 32 is disposed over a plurality of light-emitting diode (LED) packages 34, 36, 38, 40, the light guide 32 being disposed adjacent to the LED packages 34, 36, 38, 40. Each LED package 34, 36, 38, 40 may be disposed on and/or electrically connected to a printed circuit board 42. The face 20 of the indicator dial 12 may be disposed adjacent to the printed circuit board 42 and the light guide 32, and the face 20 may have cutouts 21 formed therein, through which the LED packages 34, 36, 38, 40 extend and/or shine through. The cutouts 21 may be holes in the face 20, or the cutouts may be transparent portions of the face 20, by way of example.

In a circular or diamond pattern, the first LED package 34 is disposed adjacent to the second LED package 36; the second LED package 36 is disposed adjacent to the third LED package 38; the third LED package 38 is disposed adjacent to the fourth LED package 40; and the fourth LED package 40 is disposed adjacent to the first LED package 34. It should be understood, however, that any desirable number of LED packages 34, 36, 38, 40 could be used. Further, the LED packages 34, 36, 38, 40 could be disposed in any desirable pattern or configuration. Each of the LED packages 34, 36, 38, 40 is spaced apart from each other. That is, the LED packages 34, 36, 38, 40 do not directly contact each other, in this example. The LED packages 34, 36, 38, 40 are disposed in a generally circular pattern around the circumference of a circle, with the circular-shaped light guide 32 disposed over them, in this example.

Each LED package 34, 36, 38, 40 may be a red-green-blue (RGB) LED package or other type of LED package that includes a plurality of colored lights. The LED packages 34, 36, 38, 40 could also alternatively be another type of equivalent light and need not necessarily be formed of light-emitting diodes. Each LED package 34, 36, 38, 40 may have a first-colored light (such as red), a second-colored light (such as yellow), and a third-colored light (such as blue). Each LED package 34, 36, 38, 40 is configured to light up one or more of its respective colored lights at a time. Each LED package 34, 36, 38, 40 may be reconfigurable to display one or more colors at a time from one or more of its respective colored lights. Thus, each LED package 34, 36, 38, 40 may be reconfigurable to display only a first color, only a second color, only a third color, or any combination of the colors.

As can be seen in FIGS. 2A-2C, the first LED package 34 is shown illuminating a first-colored light to display a first color (in this case, red) with a first intensity. In FIGS. 2A-2C, the first LED package 34 illuminates 100% intensity of the red color and 0% intensity of any other color of the lights of the LED package 34. The second LED package 36 is shown illuminating a first-colored light to display the first color (in this case, red) with a second intensity and a second-colored light to display a second color (in this case, yellow) with a first intensity. In FIGS. 2A-2C, the second LED package 36 illuminates 50% intensity of the red color, 50% intensity of the yellow color, and 0% intensity of a blue or green light of the LED package 36. The third LED package 38 is shown illuminating a light to display the second color (in this case, yellow) with a second intensity. In FIGS. 2A-2C, the third LED package 38 illuminates 100% intensity of the yellow color and 0% intensity of any other color of the LED package 38. Like the second LED package 36, the fourth LED package 40 is shown illuminating a light to display the first color (in this case, red) and a light to display the second color (in this case, yellow) with partial intensities. In FIGS. 2A-2C, the fourth LED package 40 illuminates 50% intensity of the red color, 50% intensity of the yellow color, and 0% intensity of a blue or green light of the LED package 40.

The lighting of the LED packages 34, 36, 38, 40 with the particular intensities of the colored lights as described above provides an appearance of a gradient between the LED packages 34, 36, 38, 40. For example, in a zone 44 adjacent to the first LED package 34, a viewer will see mostly red light. The viewer will see mostly orange light, however, in a zone 46 adjacent to the LED package 36, which currently shows equal intensities of red and yellow light. As the viewer looks along the light guide 32 from the first LED package 34 toward the second LED package 36, the color will change from all red to a color that is less and less red along the light guide 32 moving away from the first LED package 34, becoming more and more orange toward the second LED package 36. Thus, in the transitional zone 48 between the zones 44 and 46, a light color between red and orange will be visible. It should be understood, however, that a continuous gradient of light color is seen by the viewer between the first and second LED packages 34, 36, and there is no actual line separating the zones 44, 48, 46.

Similarly, in a zone 50 adjacent to the third LED package 38, a viewer will see mostly yellow light. As the viewer looks along the light guide 32 from the second LED package 36 toward the third LED package 38, the color will change from all orange to a color that is less and less orange along the light guide 32 moving away from the second LED package 36, becoming more and more yellow toward the third LED package 38. Thus, in the transitional zone 52 between the zones 46 and 50, a light color between orange and yellow will be visible. It should be understood, however, that a continuous gradient of light color is seen by the viewer between the second and third LED packages 36, 38, and there is no actual line separating the zones 46, 52, 50.

Likewise, in a zone 54 adjacent to the fourth LED package 38, a viewer will see mostly orange light, as the fourth LED package 40 currently shows equal intensities of red and yellow light. As the viewer looks along the light guide 32 from the third LED package 38 toward the fourth LED package 40, the color will change from all yellow to a color that is less and less yellow along the light guide 32 moving away from the third LED package 38, becoming more and more orange toward the fourth LED package 40. Thus, in the transitional zone 56 between the zones 50 and 54, a light color between yellow and orange will be visible. It should be understood, however, that a continuous gradient of light color is seen by the viewer between the third and fourth LED packages 38, 40, and there is no actual line separating the zones 50, 56, 54.

As the viewer looks along the light guide 32 from the fourth LED package 40 (which shows an orange color due to illuminating equal intensities of a red-colored light and a yellow-colored-light) toward the first LED package 34 (which shows a red color due to illuminating a red-colored light only), the color will change from all orange to a color that is less and less orange along the light guide 32 moving away from the fourth LED package 40, becoming more and more red toward the first LED package 34. Thus, in the transitional zone 58 between the zones 54 and 44, a light color between orange and red will be visible. It should be understood, however, that a continuous gradient of light color is seen by the viewer between the fourth and first LED packages 40, 34, and there is no actual line separating the zones 54, 58, 44.

Thus, the light colors displayed by the LED packages 34, 36, 38, 40 are blended by virtue of illuminating varying intensities of the colored lights in the adjacent LED packages 34, 36, 38, 40. For example, at least one same-colored-light is illuminated in adjacent LED 34, 36, 38, 40, albeit in varying intensities. The light guide 32 is configured to further blend the displayed colors to provide a smooth, gradient appearance for the viewer.

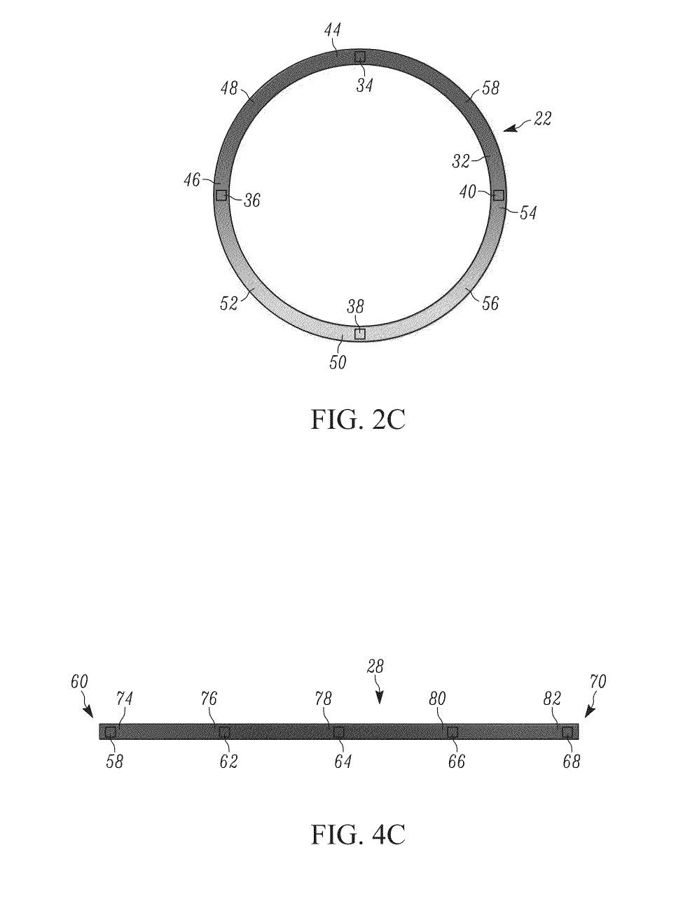

FIGS. 2A-2C illustrate a certain color configuration through the frame 22 at a first time. In some variations, the frame 22 is reconfigurable to change the colors displayed by one or more of the LED packages 34, 36, 38, 40. Accordingly, at a second time that is different than the first time, the first LED package 34 may be reconfigured to illuminate a full or partial intensity of one of its colored lights other than the red light. The LED package 34 may illuminate, for example, a yellow light or a blue light, at full or partial intensities. The yellow or blue light may be illuminated simultaneously with an intensity of the red light, if desired. Accordingly, the color displayed by the first LED package 34 will change from all red as shown in FIGS. 2A-2C to another color, such as orange, yellow, blue, green, violet, or any desired color, at the second time. The same is true for each of the other LED packages 36, 38, 40. For example, the colors may be changed in the frame 22 to display colors similar to those illustrated in the indicator strip 28 in FIGS. 4A-4C. Accordingly, an operator may switch between two or more color schemes for a desired aesthetic appearance. In some variations, each color scheme may include a gradient appearance of blended colors.

Referring now to FIGS. 4A-4C, additional details of the strip indicator 28 are shown and described. The strip indicator 28 may be similar to the frame 22, except that it has a linear, straight-line shape, as opposed to the circular shape of the frame 22. Accordingly, any details of the frame 22 may be understood to also apply to the strip indicator 28 embodiment, and vice versa.

FIG. 4A is a black-and-white line drawing of the strip indicator 28, while FIG. 2B is a grayscale view of the strip indicator 28, and FIG. 2C illustrates the strip indicator 28 in color. Though a side view is not shown, from the side, the strip indicator 28 may appear similar to the frame 22, as shown in FIG. 3. For example, the strip indicator 28 may have a light guide disposed adjacent to a plurality of LED packages that are disposed on and/or electrically connected to a printed circuit board.

The strip indicator 28 has a first LED package 58 disposed at a first end 60 of the strip indicator 28. The first LED package 58 is disposed adjacent to a second LED package 62; the second LED package 62 is disposed adjacent to a third LED package 64; the third LED package 64 is disposed adjacent to a fourth LED package 66; and the fourth LED package 66 is disposed adjacent to a fifth LED package 68, the fifth LED package 68 being disposed at a second end 70 of the strip indicator 28. It should be understood, however, that any desirable number of LED packages 58, 62, 64, 66, 68 could be used. Each of the LED packages 58, 62, 64, 66, 68 is spaced apart from each other. That is, the LED packages 58, 62, 64, 66, 68 do not directly contact each other, in this example. The LED packages 58, 62, 64, 66, 68 are disposed in a generally linear, straight-line pattern, along an axis, with an elongate rectangular light guide 72, or linear-shaped light guide 72, disposed over the LED packages 58, 62, 64, 66, 68, in this example.

Each LED package 58, 62, 64, 66, 68 may be a red-green-blue (RGB) LED package or other type of LED package or other lighting device that includes a plurality of colored lights. Thus, each LED package 58, 62, 64, 66, 68 may have a first-colored light (such as red), a second-colored light (such as yellow), and a third-colored light (such as blue). Each LED package 58, 62, 64, 66, 68 is configured to illuminate one or more of its respective colored lights at a time. Each LED package 58, 62, 64, 66, 68 may be reconfigurable to display one or more colors at a time from one or more of its respective colored lights. Thus, each LED package 58, 62, 64, 66, 68 may be reconfigurable to display only a first color, only a second color, only a third color, or any combination of the colors.

As can be seen in FIGS. 4A-4C, the first LED package 58 is shown illuminating a first-colored light to display a first color (in this case, blue) with a first intensity. In FIGS. 4A-4C, the first LED package 58 illuminates 100% intensity of the red color and 0% intensity of any other color of the lights of the LED package 58. The second LED package 62 is shown displaying the first color (blue) with a second intensity and a second color (red) with a first intensity. In FIGS. 4A-4C, the second LED package 62 displays 75% intensity of the blue color, 25% intensity of the red color, and 0% intensity of a yellow or green light of the LED package 62. The third LED package 64 is shown displaying the first color (blue) with a third intensity and the second color (red) with a second intensity. In FIGS. 4A-4C, the third LED package 64 displays 50% intensity of the blue color, 50% intensity of the red color, and 0% intensity of a yellow or green light of the LED package 64. The fourth LED package 66 is shown displaying the first color (blue) with a fourth intensity and the second color (red) with a third intensity. In FIGS. 4A-4C, the fourth LED package 66 displays 25% intensity of the blue color, 75% intensity of the red color, and 0% intensity of a yellow or green light of the LED package 66. The fifth LED package 68 is shown displaying the second color (red) with a fourth intensity. In FIGS. 4A-4C, the fifth LED package 68 displays 100% intensity of the red color and 0% intensity of any other color of the LED package 68.

The lighting of the LED packages 58, 62, 64, 66, 68 with the particular intensities of the colored lights as described above provides an appearance of a color gradient between the LED packages 58, 62, 64, 66, 68. For example, in a zone 74 adjacent to the first LED package 58, a viewer will see mostly blue light. The viewer will see a slightly reddish-blue light, however, in a zone 76 adjacent to the second LED package 62, which displays red and blue lights with a higher intensity of blue. As the viewer looks along the light guide 72 from the first LED package 58 toward the second LED package 62, the color will change from all blue to a color that is slightly less blue and having some red along the light guide 72 moving away from the first LED package 58, becoming more and more dark violet (75% blue and 25% red) toward the second LED package 62 in the zone 76. It should be understood, however, that a continuous gradient of light color is seen by the viewer between the first and second LED packages 58, 62, and there is no actual line separating the zones 74, 76.

In a zone 78 adjacent to the third LED package 64, a viewer will see mostly violet light, as the third LED package 64 currently displays equal intensities of blue and red light. As the viewer looks along the light guide 72 from the second LED package 62 toward the third LED package 64, the color will change from dark violet to a color that is more medium violet along the light guide 72 moving away from the second LED package 62 and toward the third LED package 64. It should be understood, however, that a continuous gradient of light color is seen by the viewer between the second and third LED packages 62, 64, and there is no actual line separating the zones 76, 78.

In a zone 80 adjacent to the fourth LED package 66, a viewer will see a bluish-red light, having a light violet color, as the fourth LED package 66 currently shows 75% intensity of the red color and 25% intensity of the blue color. As the viewer looks along the light guide 72 from the third LED package 64 toward the fourth LED package 68, the color will change from medium violet to a color that is a lighter, more reddish violet along the light guide 72 moving away from the third LED package 64 and toward the fourth LED package 66. It should be understood, however, that a continuous gradient of light color is seen by the viewer between the third and fourth LED packages 64, 66, and there is no actual line separating the zones 78, 80.

Similarly, in a zone 82 adjacent to the fifth LED package 68, a viewer will see mostly or all red light. As the viewer looks along the light guide 72 from the fourth LED package 66 toward the fifth LED package 68, the color will change from light violet or bluish-red to a color that is less and less violet along the light guide 72 moving away from the fourth LED package 66, becoming more and more red toward the fifth LED package 68. It should be understood, however, that a continuous gradient of light color is seen by the viewer between the fourth and fifth LED packages 66, 68, and there is no actual line separating the zones 80, 82.

Thus, the light colors illuminated by the LED packages 58, 62, 64, 66, 68 are blended by virtue of illuminating varying intensities of the colors in the adjacent LED packages 58, 62, 64, 66, 68. For example, at least one same-colored-light is illuminated in adjacent LED packages 58, 62, 64, 66, 68, albeit in varying intensities. The light guide 72 is configured to further blend the displayed colors to provide a smooth, gradient appearance for the viewer.

FIGS. 4A-4C illustrate a certain color scheme displayed by the strip indicator 28 at a first time. In some variations, the strip indicator 28 is reconfigurable to change the colors displayed by one or more of the LED packages 58, 62, 64, 66, 68. Accordingly, at a second time that is different than the first time, the first LED package 58 may be reconfigured to illuminate a certain intensity of one of its colored lights other than the blue light. The LED package 58 may illuminate, for example, a yellow light or a red light, at full or partial intensities. The yellow or red light may be illuminated simultaneously with an intensity of the blue light, if desired. Accordingly, the color displayed by the first LED package 58 will change from all blue as shown in FIGS. 4A-4C to another color, such as orange, yellow, red, green, violet, or any desired color, at the second time. The same is true for each of the other LED packages 62, 64, 66, 68. For example, the colors may be changed along the strip indicator 28 to display colors similar to those illustrated in the indicator dial 12 in FIGS. 2A-2C. Accordingly, an operator may switch between two or more color schemes for a desired aesthetic appearance. In some variations, each color scheme may include a gradient appearance of blended colors.

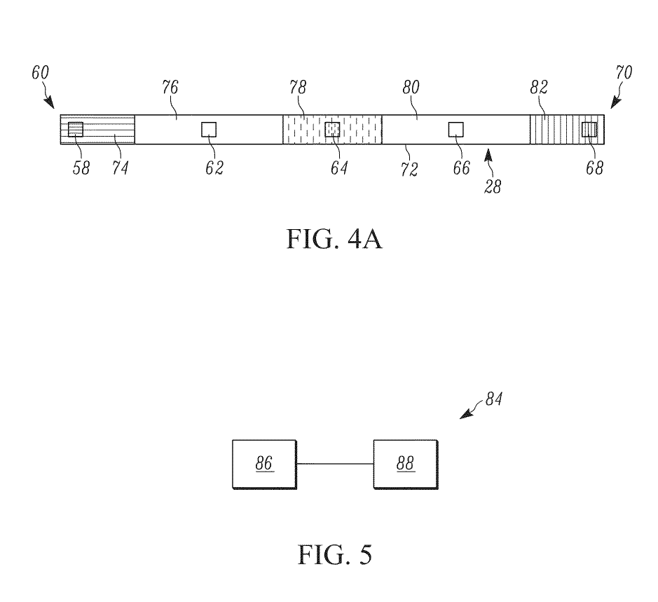

Referring now to FIG. 5, a system for illuminating an instrument cluster assembly 10, including one or both of the indicator dial 12 and the strip indicator 28, is illustrated and generally indicated at 84. The system 84 includes a processor 86 that is in controlling communication with a set of LED packages 88, which may include one or more of the LED packages 34, 36, 38, 40, 58, 62, 64, 66, 68 described above. The system 84 may also include any of the other components shown and described above with respect to FIGS. 1-4C.

The processor 86 is configured to cause a first LED package (one of 34, 36, 38, 40, 58, 62, 64, 66, 68) to display a first intensity of a first displayed color at a first time and to cause a second LED package (another of 34, 36, 38, 40, 58, 62, 64, 66, 68) to display a second intensity of the first displayed color at the first time. The second intensity of the first displayed color is either greater than or less than the first intensity of the first displayed color to provide an appearance of a color gradient between the first and second LED packages of the set 88. The second LED package may also be lit up to display a partial intensity of second color, as described above with reference to FIGS. 2A-2C and 4A-4C.

The processor 86 is also configured to cause the LED packages 88 to be reconfigured to display at least one second color. For example, the processor 86 is configured to cause the first LED package (one of 34, 36, 38, 40, 58, 62, 64, 66, 68) to display a first intensity of the second displayed color at a second time, the first time being different than the second time. For example, a first LED package 34 may be caused by the processor 86 to first display a first color, such as red, at a first time; and then, the processor 86 may cause the first LED package 34 to display a second color (such as yellow or a blended color like orange) at a second time, so that the first displayed color is different than the second displayed color. Likewise, the processor 86 may be configured to cause all of the LED packages 34, 36, 38, 40, 58, 62, 64, 66, 68 or others to display primary colors or blended colors, as shown and described above in FIGS. 2A-2C and 4A-4C, and then to be reconfigured to each display different primary or blended colors.

The processor 86 may receive an input signal from an external system (such as a switch or message), which is fed into the processor 86. For example, a user may input a desired color scheme into the system 84. The processor 86 is then configured to adjust the color of one or more of the LED packages 34, 36, 38, 40, 58, 62, 64, 66, 68 to achieve various primary colors and various blended colors, which are a percentage of the primary colors based on physical location to one another, as described above. For example, each blended color may include at least a partial intensity of the same color as that of an LED package 34, 36, 38, 40, 58, 62, 64, 66, 68 disposed adjacent thereto.

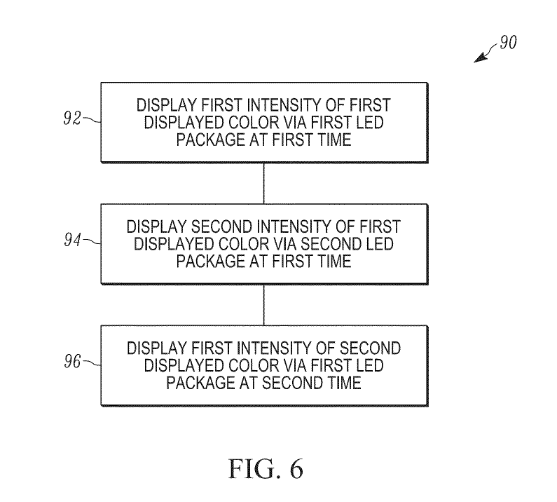

Referring now to FIG. 6, a method for illuminating an instrument cluster assembly is illustrated and generally designated at 90. The method 90 may be used in conjunction with the frame 22, the indicator strip 28, and/or the system 84 described above, or separately therefrom. The method 90 includes a step 92 of displaying a first intensity of a first displayed color via a first LED package at a first time. For example, the first LED packages 34, 58 of FIGS. 2A-2C and/or 4A-4C may display 100% intensity of a red color or a blue color at a point in time.

The method 90 further includes a step 94 of displaying a second intensity of the first displayed color via a second LED package at the first time. The second intensity is less than (or may be greater than) the first intensity to provide an appearance of a color gradient between the first and second LED packages at the first time. The method 90 also includes a step 96 of displaying a first intensity of a second displayed color via the first LED package at a second time. For example, the first LED package may be reconfigured to display a second color after displaying the first color.

The method 90 may also include any number of other steps to effect the lighting configurations or color schemes as described above with respect to FIGS. 2A-2C, 4A-4C, and 5. For example, the method 90 may also include a step of displaying a second intensity of the second displayed color via the second light-emitting diode package at the first time, so that the second displayed color is a blended color as described above. Further, the method 90 may include displaying a third intensity of the second displayed color via a third LED package at the first time, the second intensity of the second displayed color being less than (or greater than) the third intensity of the second displayed color to provide an appearance of a color gradient between the second and third LED packages at the first time. In addition, the method 90 may include displaying a first intensity of a third displayed color via the first LED package at a third time. For example, the first LED package (and any of the other LED packages) may be reconfigured yet again to display a third color pattern or color scheme.

In some variations, dedicated hardware implementations, such as application specific integrated circuits, programmable logic arrays and other hardware devices, can be constructed to implement the method 90, or a variation on the method 90, described herein. Applications that may include the apparatus and systems of various embodiments disclosed herein can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the method 90 described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further, the method 90, and/or any parts of the system 84, described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor (such as processor 86) or that cause a computer system to perform the method 90 or a variation thereof, or any other methods or operations described herein.

Thus, the method 90 may be performed by a non-transitory machine-readable medium that provides instructions, which when executed by a machine, cause the machine to perform the steps of the method 90. The instructions may be stored in a computer-readable medium such as memory or storage device, for example, a disk drive, CD, or DVD. The computer may include a display controller responsive to instructions to generate a textual or graphical display on a display device, for example a computer monitor or display screen visible to a driver or passenger. In addition, the processor (for example, processor 86) may communicate with a network controller to communicate data or instructions to other systems, for example, other general computer systems. The network controller may communicate over Ethernet or other known protocols to distribute processing or provide remote access to information over a variety of network topologies, including local area networks, wide area networks, the Internet, or other commonly used network topologies.

It is further understood that any of the above described concepts can be used alone or in combination with any or all of the other above described concepts. As a person skilled in the art will readily appreciate, the above description is meant as one illustration of the principles of the invention. This description is not intended to limit the scope or application of the invention in that the invention is susceptible to modification, variation, and change, without departing from the spirit and scope of the invention, as defined in the following claims.

What is claimed is:

1. An instrument cluster assembly comprising:
a first light-emitting diode package having a first-colored light and a second-colored light, the first light-emitting diode package being reconfigurable to display a first color and a second color, the first light-emitting diode package being configured to display a first intensity of the first color; and
a second light-emitting diode package having a first-colored light and a second-colored light, the second light-emitting diode package being disposed adjacent to the first light-emitting diode package and spaced apart from the first light-emitting diode package, the second light-emitting diode package being reconfigurable to display the first color and the second color, the second light-emitting diode package being configured to display a second intensity of the first color simultaneously with the display of the first intensity of the first color by the first light-emitting diode package, the second intensity of the first color being less than the first intensity of the first color to provide an appearance of a gradient between the first and second light-emitting diode packages.

2. The instrument cluster assembly of claim 1, further comprising at least one light guide disposed adjacent to the first and second light-emitting diode packages, the at least one light guide being configured to blend the displayed colors of the first and second light-emitting diode packages.

3. The instrument cluster assembly of claim 2, further comprising a printed circuit board, the first and second light-emitting diode packages being electrically connected to the printed circuit board.

4. The instrument cluster assembly of claim 3, the first light-emitting diode package being configured to display the first intensity of the first color at a first time, the first light-emitting diode package being configured to display a first intensity of the second color at a second time, the first time being different than the second time.

5. The instrument cluster assembly of claim 4, further comprising a third light-emitting diode package having a first-colored light and a second-colored light, the third light-emitting diode package being disposed adjacent to the second light-emitting diode package and spaced apart from the second light-emitting diode package, the at least one light guide being disposed adjacent to the third light-emitting diode package, the third light-emitting diode package being reconfigurable to display the first color and the second color, the second light-emitting diode package being configured to display the second intensity of the first color at the first time, the second light-emitting diode package being configured to display a second intensity of the second color at the first time, the third light-emitting diode package being configured to display a third intensity of the second color at the first time, the second intensity of the second color being less than the third intensity of the second color to provide an appearance of a color gradient between the second and third light-emitting diode packages.

6. The instrument cluster assembly of claim 5, the third light-emitting diode package being configured to display a third intensity of the first color at the second time.

7. The instrument cluster assembly of claim 6, wherein each of the first, second, and third light-emitting diode packages has a third-colored light, each of the first, second, and third light-emitting diode packages being configured to display a third color.

8. The instrument cluster assembly of claim 7, wherein each of the first, second, and third light-emitting diode packages are red-green-blue (RGB) light-emitting diode packages.

9. The instrument cluster assembly of claim 8, wherein the first, second, and third light-emitting diode packages are arranged generally in a circular pattern, the at least one light guide having a circular shape.

10. The instrument cluster assembly of claim 9, further comprising a fourth light-emitting diode package disposed adjacent to the first light-emitting diode package and the third light-emitting diode package, the fourth light-emitting diode package having a first-colored light, a second-colored light, and a third-colored light, the fourth light-emitting diode package being reconfigurable to display first, second, and third colors, the fourth light-emitting diode package being configured to display a fourth intensity of the first color and a fourth intensity of the second color at the first time.

11. The instrument cluster assembly of claim 4, further comprising a third light-emitting diode package having a first-colored light, a second-colored light, and a third-colored light, the first and second light-emitting diode packages each having a third-colored light, the third light-emitting diode package being disposed adjacent to the second light-emitting diode package and spaced apart from the second light-emitting diode package, the at least one light guide being disposed adjacent to the third light-emitting diode package, the third light-emitting diode package being reconfigurable to display the first and second colors, wherein the first, second, and third light-emitting diode packages are arranged along an axis, the at least one light guide having a linear shape.

12. A system for illuminating an instrument cluster assembly, the system comprising:
a first light-emitting diode package having a first-colored light and a second-colored light, the first light-emitting diode package being reconfigurable to display a first displayed color and a second displayed color; and
a second light-emitting diode package having a first-colored light and a second-colored light, the second light-emitting diode package being disposed adjacent to the first light-emitting diode package and spaced apart from the first light-emitting diode package, the second light-emitting diode package being reconfigurable to display the first displayed color and the second displayed color; and
a processor controllably connected to the first light-emitting diode package and the second light-emitting diode package, the processor being configured to cause the first light-emitting diode package to display a first intensity of the first displayed color at a first time and to cause the second light-emitting diode package to display a second intensity of the first displayed color at the first time, the second intensity of the first displayed color being less than the first intensity of the first displayed color to provide an appearance of a gradient between the first and second light-emitting diode packages.

13. The system of claim 12, the processor being further configured to cause the first light-emitting diode package to display a first intensity of the second displayed color at a second time, the first time being different than the second time.

14. The system of claim 13, further comprising a third light-emitting diode package having a first-colored light and a second-colored light, the third light-emitting diode package being disposed adjacent to the second light-emitting diode package and spaced apart from the second light-emitting diode package, the third light-emitting diode package being reconfigurable to display the first displayed color and the second displayed color, the processor being controllably connected to the third light-emitting diode package, the processor being configured to cause the second light-emitting diode package to display a second intensity of the second displayed color at the first time, the processor being further configured to cause the third light-emitting diode package to display a third intensity of the second displayed color at the first time, the second intensity of the second displayed color being less than the third intensity of the second displayed color to provide an appearance of a color gradient between the second and third light-emitting diode packages.

15. The system of claim 14, further comprising at least one light guide disposed adjacent to the first, second, and third light-emitting diode packages, each of the first, second, and third light-emitting diode packages having a third-colored light, each of the first, second, and third light-emitting diode packages being configured to display a third displayed color, the at least one light guide being configured to blend the displayed colors of the first, second, and third light-emitting diode packages.

16. A non-transitory machine-readable medium that provides instructions, which when executed by a machine, cause the machine to perform the following operations comprising:
displaying a first intensity of a first displayed color via a first light-emitting diode package at a first time;
displaying a second intensity of the first displayed color via a second light-emitting diode package at the first time, the second intensity being less than the first intensity to provide an appearance of a gradient between the first and second light-emitting diode packages at the first time; and
displaying a first intensity of a second displayed color via the first light-emitting diode package at a second time.

17. The non-transitory machine-readable medium of claim 16, wherein the instructions further cause the machine to perform the operation of displaying a second intensity of the second displayed color via the second light-emitting diode package at the first time.

18. The non-transitory machine-readable medium of claim 17, wherein the instructions further cause the machine to perform the operation of displaying a third intensity of the second displayed color via a third light-emitting diode package at the first time, the second intensity of the second displayed color being less than the third intensity of the second displayed color to provide an appearance of a color gradient between the second and third light-emitting diode packages at the first time.

19. The non-transitory machine-readable medium of claim 18, wherein the instructions further cause the machine to perform the operation of displaying a first intensity of a third displayed color via the first light-emitting diode package at a third time.
